(19) United States
(12) Patent Application Publication
(10) Pub. No.: US 2016/0091996 A1
(43) Pub. Date: Mar. 31, 2016

(54) LIFTOFF INPUT DETECTION

(71) Applicant: Apple Inc., Cupertino, CA (US)

(72) Inventor: James E. Vest, San Francisco, CA (US)

(73) Assignee: Apple Inc., Cupertino, CA (US)

(21) Appl. No.: 14/502,973

(22) Filed: Sep. 30, 2014

(51) Int. Cl. G06F 3/041; G06F 3/0485; G06F 3/0484; G06F 3/0488

(52) U.S. Cl. CPC G06F 3/041; G06F 3/0488; G06F 3/0485; G06F 3/04842; G06F 3/04845; G06F 2203/04104; G06F 2203/04808

(57) ABSTRACT

An electronic device including one or more processors, a touch-sensitive surface, and memory detects a contact area of a set of one or more contacts on the touch-sensitive surface. A plurality of changes in the contact area are mapped to corresponding predefined responses. After detecting the contact area, a change in the contact area that includes a liftoff of at least a portion of the set of one or more contacts from the touch-sensitive surface is detected. In response to detecting the change in the contact area, in accordance with a determination that the change is a first change in the contact area, a first predefined response is performed. In accordance with a determination that the change is a second change in the contact area, a second predefined response that is different from the first predefined response is performed.

### BACKGROUND

The disclosed embodiments relate generally to assistive technology and more particularly to techniques for receiving user input at a touch-sensitive surface.

Assistive devices can be used in lieu of or in conjunction with input devices such as a keyboard and mouse to provide user input to computing devices. Assistive devices improve the usability of computing devices for physically impaired users. For example, a user who cannot use a hand to provide input to a computing device can use a foot to provide input via an assistive device.

In some circumstances, an assistive device is a switch control. Currently available switch controls include, for example, a button to be pressed by hand or foot. A switch control can be used in conjunction with switch access scanning. Switch access scanning allows selection of input options using a switch. In one example, switch access scanning involves sequentially highlighting, by a computing device, displayed selectable input options such as onscreen buttons, menu items, files, etc. A selectable input option is selectable when a switch is activated, e.g., when a user presses a button, while the selectable input option is highlighted.

Currently, a tapping input received at a touchscreen can be used as a switch control. However, for various users, alternative techniques for receiving switch control input at a touch-sensitive surface have the potential to provide an improved user experience.

### BRIEF SUMMARY

Certain embodiments are described that provide improved techniques for receiving switch control input at a touch-sensitive surface.

In an embodiment, a method is disclosed. The method includes, at an electronic device including one or more processors, a touch-sensitive surface, and memory, detecting a contact area of a set of one or more contacts on the touch-sensitive surface. A plurality of changes in the contact area are mapped to corresponding predefined responses. After detecting the contact area, a change in the contact area that includes a liftoff of at least a portion of the set of one or more contacts from the touch-sensitive surface is detected while at least a portion of the contact area is maintained on the touch-sensitive surface. In response to detecting the change in the contact area, in accordance with a determination that the change is a first change in the contact area, a first predefined response is performed. In accordance with a determination that the change is a second change in the contact area, a second predefined response that is different from the first predefined response is performed.

In another embodiment, an electronic device is disclosed. The electronic device includes one or more processors, a touch-sensitive surface, memory, and one or more programs. The one or more programs are stored in the memory and are configured to be executed by the one or more processors. The one or more programs include instructions for detecting a contact area of a set of one or more contacts on the touch-sensitive surface. The one or more programs further include instructions for mapping a plurality of changes in the contact area to corresponding predefined responses. The one or more programs additionally include instructions for, after detecting the contact area, detecting a change in the contact area that includes a liftoff of at least a portion of the set of one or more contacts from the touch-sensitive surface while at least a portion of the contact area is maintained on the touch-sensitive surface. In response to detecting the change in the contact area, in accordance with a determination that the change is a first change in the contact area, a first predefined response is performed. In accordance with a determination that the change is a second change in the contact area, a second predefined response that is different from the first predefined response is performed.

In an additional embodiment, a non-transitory computer readable storage medium storing one or more programs is disclosed. The one or more programs include instructions, which when executed by an electronic device with one or more processors and memory, cause the device to detect a contact area of a set of one or more contacts on the touch-sensitive surface. The one or more programs further include instructions for mapping a plurality of changes in the contact area to corresponding predefined responses. The one or more programs additionally include instructions for, after detecting the contact area, detecting a change in the contact area that includes a liftoff of at least a portion of the set of one or more contacts from the touch-sensitive surface while at least a portion of the contact area is maintained on the touch-sensitive surface. In response to detecting the change in the contact area, in accordance with a determination that the change is a first change in the contact area, a first predefined response is performed. In accordance with a determination that the change is a second change in the contact area, a second predefined response that is different from the first predefined response is performed.

In a further embodiment, an electronic device with one or more processors, a touch-sensitive surface, and memory detects a contact of three digits on the touch-sensitive surface. A liftoff of at least one digit of the three digits is detected. A liftoff of a first digit of the three digits is mapped to a predefined response. A liftoff of at least one of a second digit and a third digit of the three digits is mapped to a second predefined response. In response to detecting the liftoff of the at least one digit of the three digits, in accordance with detecting a liftoff of the first digit of the three digits, a first predetermined response is performed. In accordance with detecting a liftoff of at least one of the second digit and the third digit of the three digits, a second predefined response that is different from the predefined response is performed.

### BRIEF DESCRIPTION OF THE DRAWINGS

FIGS. 1A-1F illustrate contact areas between multiple fingers and a touch-sensitive surface, according to an embodiment.

FIGS. 2A-2F illustrate contact areas between a palm of a foot and a touch-sensitive surface, according to an embodiment.

FIG. 3 illustrates an accessory device including a touch-sensitive surface, according to an embodiment.

FIG. 4 illustrates a portable device including a touch-sensitive surface that is a touchscreen, according to an embodiment.

FIG. 5 is a flow diagram for prompting a user to define input settings, in accordance with an embodiment.

FIG. 6 is a flow diagram for providing input to a device via a touch-sensitive surface, according to an embodiment.

FIGS. 7A-7B illustrate advancing a selection indicator to a next selectable interface element of a set of selectable interface elements, according to an embodiment.

FIGS. 8A-8B illustrate a contact area received at different portions of a touch-sensitive screen, according to an embodiment.

FIGS. 9A-9B illustrate various arrangements of discrete contact points of a contact area, according to an embodiment.

FIGS. 10A-10B illustrate a contact area provided by a right hand and a contact area provided by a left hand at touch-sensitive screen, according to an embodiment.

FIG. 11 is a simplified block diagram of a computer system, according to an embodiment.

### DETAILED DESCRIPTION

In the following description, for the purposes of explanation, specific details are set forth in order to provide a thorough understanding of embodiments of the invention. However, it will be apparent that various embodiments are practicable without these specific details. The figures and description are not intended to be restrictive.

When a user has limited mobility or other impairment, the user may have difficulty providing a tapping, keying, or other input that requires hovering over a surface. Various users may prefer to maintain resting contact with a touch-sensitive surface and provide input via a control associated with movement from the resting contact. In this way, a user maintains contact with a touch-sensitive surface in a resting position, such as resting fingers, a foot, etc., on a touch-sensitive surface. The user provides input by lifting fingers, rolling a foot to the side, or otherwise changing the contact area relative to the initial contact area.

Certain embodiments are described that provide a device including a touch-sensitive surface. A touch-sensitive surface can detect a contact area where one or more contacts occur with the surface.

A contact area is, in some embodiments, multiple fingers in contact with a touch-sensitive surface. After the touch-sensitive surface has detected a contact area, the touch-sensitive surface detects a change in the contact area resulting from a liftoff of a portion of the contacts with the touch-sensitive surface. If the contact area is multiple fingers in contact with a touch-sensitive surface, the liftoff is, in various examples, one or more fingers of the multiple fingers raised off the touch-sensitive surface while the other fingers remain in contact with the touch-sensitive surface.

In another example, a contact is a foot in contact with a touch-sensitive surface. A liftoff of a portion of the contact occurs when a user rolls, slides or otherwise moves the foot from side to side, front to back, etc., resulting in a changed contact between the foot and the touch-sensitive surface.

When a device detects a liftoff of a portion of the contacts resulting in a changed contact area, a predefined response occurs. For example, when multiple fingers are in contact with the touch-sensitive surface, a liftoff of some of the fingers triggers a predefined response, such as selection of a selectable item highlighted on a display.

For purposes of this disclosure, the term “touch-sensitive surface” can refer to a device or device component configured to receive contact at one or more areas of a surface and produce a signal including information about the contact. A device including a touch-sensitive surface, in some examples, produces a signal indicating that one or more fingers, hands, toes, feet, other parts of the human body, or other objects are in contact with the surface. The touch-sensitive surface is, in certain embodiments, a touchscreen with a surface that includes a device display. Another example of a touch-sensitive surface is a track pad, such as a track pad capable of detecting multiple discrete contacts. In some embodiments, a touch-sensitive surface includes one or more sensors, such as resistive, acoustic, capacitive, optical, infrared, or other sensors, for detecting one or more contacts occurring at touch-sensitive surface. A signal produced by a touch-sensitive surface optionally includes information about locations of one or more contact areas, such as coordinates indicating pixels or other subdivisions of the surface at which contact occurs. The signal occurs, in some examples, when an object comes into contact with the touch-sensitive surface and/or when an object ceases to be in contact with the touch-sensitive surface.

For purposes of this disclosure, the term “contact area” can refer to one or more areas of a touch sensitive surface contacted by a hand, foot, or part thereof; other part of a body, or other object.

For purposes of this disclosure, the term “liftoff” can refer to a change in contact area that occurs due to movement of a body part or object in contact with the touch-sensitive surface.

For purposes of this disclosure, the term “predefined response” can refer to an operation that is performed by an operating system, application, or other instruction set executed by one or more processors of a device. Examples of predefined responses include: selecting a currently highlighted selectable interface element, advancing a selection indicator to a next selectable interface element of a set of selectable interface elements, moving a selection indicator to a previous selectable interface element of a set of selectable interface elements, initiating scrolling between selectable interface elements, stopping scrolling between selectable interface elements, and the like. Further examples of predefined responses include adjusting a setting, such as a volume setting or a screen brightness setting, providing text input, providing gesture input, etc.

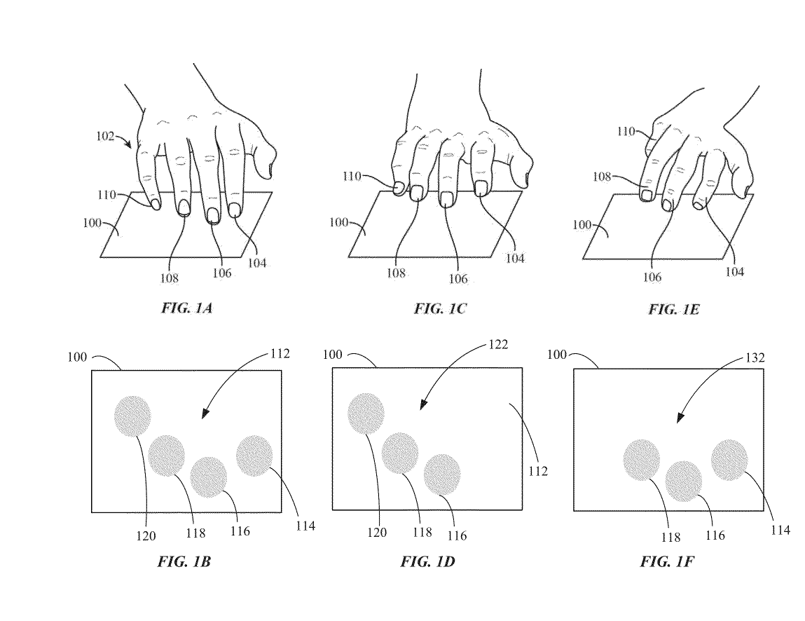

FIGS. 1A-1F illustrate contact areas between multiple fingers and a touch-sensitive surface, according to an embodiment.

FIG. 1A illustrates a resting position in which multiple user fingers 102 are in contact with a touch-sensitive surface 100. In FIG. 1A, fingers 102 in contact with touch-sensitive surface 100 include index finger 104, middle finger 106, ring finger 108, and pinky finger 110 of the hand. It will be recognized that alternative resting positions are usable, such as resting positions including fewer or more digits than shown in the illustrative depiction of FIG. 1A. In alternative embodiments, a resting position includes contact between touch-sensitive surface 100 and part or all of a hand, foot, arm, or other part of a body.

FIG. 1B shows a contact area 112 between user fingers 102 and touch-sensitive surface 100 when fingers 102 are in a resting position as depicted in FIG. 1A. Contact area 112 includes index finger contact area 114 where the index finger 104 is in contact with touch-sensitive surface 100, middle finger contact area 116 where middle finger 106 is in contact with touch-sensitive surface 100, ring finger contact area 118 where ring finger 108 is in contact with touch-sensitive surface 100, and pinky finger contact area 120 where pinky finger 110 is in contact with touch-sensitive surface 100.

FIG. 1C illustrates a first liftoff position that changes the contact area from the resting contact area 112 shown in FIG. 1B to the first altered contact area 122 shown in FIG. 1D. In FIG. 1C, the user has lifted index finger 104 off of touch-sensitive surface 100, resulting in a first liftoff position. Middle finger 106, ring finger 108, and pinky finger 110 remain in contact with touch-sensitive surface 100.

In some embodiments, a predefined response occurs when a contact area changes, e.g., from the resting contact area 112 shown in FIG. 1B to the first altered contact area 122 shown in FIG. 1D. For example, if a first predefined response is a command to select a currently highlighted selectable interface element, then the selection occurs in response to a change in the contact area, such as a change from the resting contact area 112 shown in FIG. 1B to the first liftoff contact area 122 shown in FIG. 1D.

FIG. 1D illustrates a first liftoff contact area 122 corresponding to the first liftoff position shown in FIG. 1C. First liftoff contact area 122 includes middle finger contact area 116 where middle finger 106 is in contact with touch-sensitive surface 100, ring finger contact area 118 where ring finger 108 is in contact with touch-sensitive surface 100, and pinky finger contact area 120 where pinky finger 110 is in contact with touch-sensitive surface 100.

FIG. 1E illustrates a second liftoff position that changes the contact area from the resting contact area 112 shown in FIG. 1B to the second liftoff contact area 132 shown in FIG. IF. In FIG. 1E, the user has lifted pinky finger 110 off of touch-sensitive surface 100, resulting in a second lift off position. Index finger 104, middle finger 106, and ring finger 108 remain in contact with touch-sensitive surface 100.

FIG. 1F illustrates a second liftoff contact area 132 corresponding to the first liftoff position shown in FIG. 1B. Second liftoff contact area 132 includes index finger contact area 114 where index finger 104 is in contact with touch-sensitive surface 100, middle finger contact area 116 where middle finger 106 is in contact with touch-sensitive surface 100, and ring finger contact area 118 where ring finger 108 is in contact with touch-sensitive surface 100.

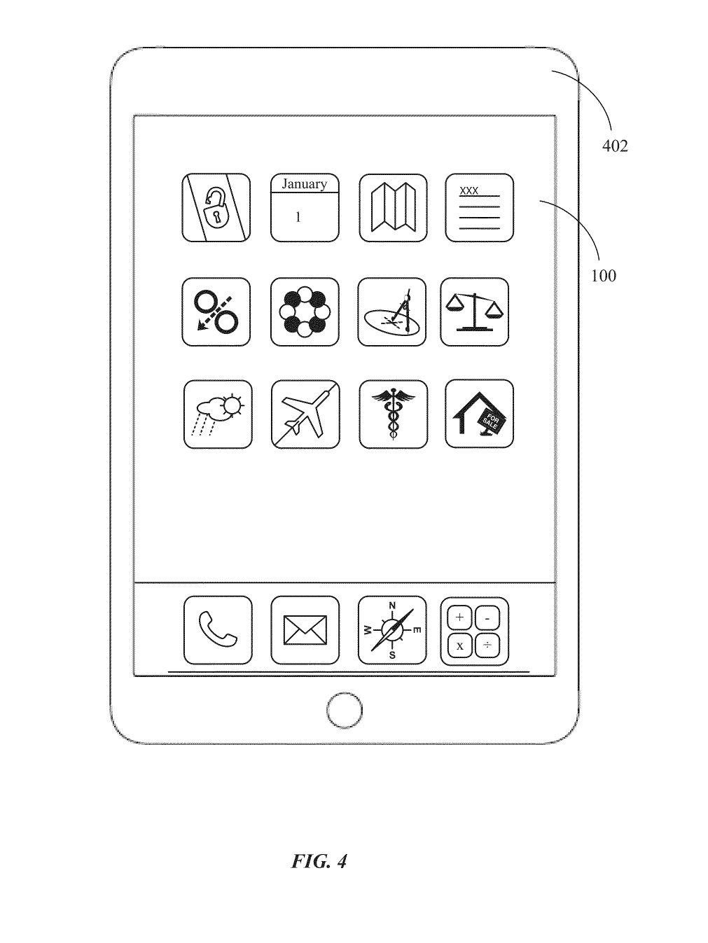

In some embodiments, a predefined response occurs when a contact area changes, e.g., from the resting contact area 112 shown in FIG. 1B to the second altered contact area 132 shown in FIG. 1E. For example, if a second predefined response is a command to advance a selection indicator to a next selectable interface element of a set of selectable interface elements, then a selection indicator is advanced in response to a change in the contact area, such as a change from the resting contact area shown in FIG. 1B to the first liftoff contact area shown in FIG. 1D. A selection indicator is described in more detail with regard to FIGS. 4A-4B.

A variety of liftoff positions are usable, such as liftoff positions that involve lifting off two or more fingers, lifting off other body parts, or lifting off other objects from touch-sensitive surface 100. In an illustrative example, a first liftoff is a liftoff of index finger 104 and middle finger 106, a second liftoff is a liftoff of ring finger 108, and a third liftoff is a liftoff of pinky finger 110. In various embodiments, different predefined responses are associated with and performed in response to each different liftoff contact area.

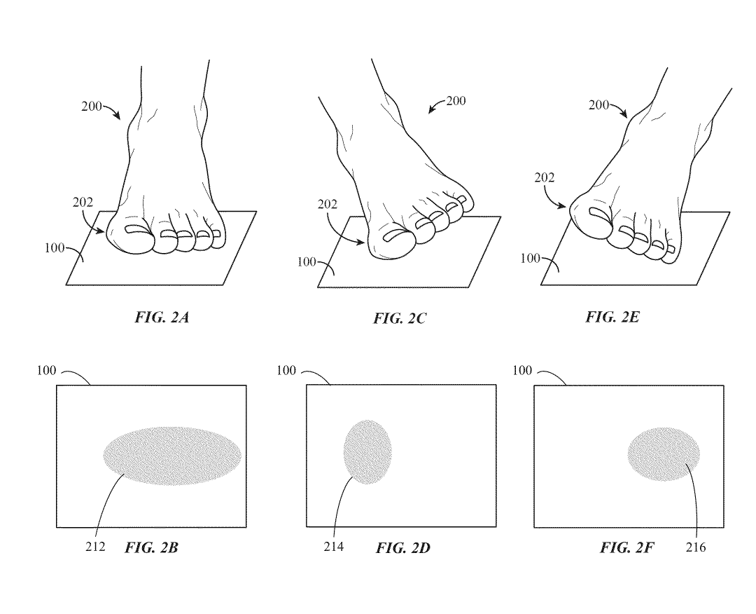

FIGS. 2A-2F illustrate contact areas between a palm of a foot and a touch-sensitive surface, according to an embodiment. A contact area between a foot and touch-sensitive surface 100 is, in various embodiments, recognized as a cluster having a particular shape, size, etc. A liftoff is detected when a change in the shape, size, etc. of the cluster changes.

FIG. 2A illustrates a resting position in which foot 200 is in contact with a touch-sensitive surface 100. In FIG. 2A, palm 202 of foot 200 is in contact with touch-sensitive surface 100. It will be recognized that alternative resting positions are usable, such as resting positions in which a heel or other portion of the foot is in contact with touch-sensitive surface 100.

FIG. 2B shows a contact area 212 between foot 200 and touch-sensitive surface 100 when palm 202 is in a resting position as depicted in FIG. 2A.

FIG. 2C illustrates a first liftoff position that changes the contact area from the resting contact area 212 shown in FIG. 2B to the first liftoff contact area 214 shown in FIG. 2D. In FIG. 2C, the user has rolled palm 202 of foot 200 in the direction of the big toe such that part of palm 202 has lifted off of touch-sensitive surface 100, resulting in a first liftoff position.

FIG. 2D illustrates a first altered contact area 214 corresponding to the first liftoff position shown in FIG. 2C. First altered contact area 214 is the portion of palm 202 of foot 200 that remains in contact with touch-sensitive surface 100 when part of palm 202 has lifted off of touch-sensitive surface 100 as shown in FIG. 2C.

FIG. 2E illustrates a second liftoff position that changes the contact area from the resting contact area 212 shown in FIG. 2B to the second liftoff contact area 216 shown in FIG. 2F. In FIG. 2E, the user has rolled palm 202 of foot 200 in the direction opposite of the big toe such that part of palm 202 has lifted off of touch-sensitive surface 100, resulting in a second liftoff position.

FIG. 2F illustrates a second liftoff contact area 216 corresponding to the second liftoff position shown in FIG. 2E. Second liftoff contact area 216 is the portion of palm 202 of foot 200 that remains in contact with touch-sensitive surface 100 when part of palm 202 has lifted off of touch-sensitive surface 100 as shown in FIG. 2E.

In some embodiments, switch input provided with a foot involves a liftoff occurring when a foot is rolled forward and backward or moved with any other motion detectable by touch-sensitive surface 100.

In accordance with various embodiments, touch-sensitive surface 100 is an accessory device configured to communicate with a computing device. For example, touch-sensitive surface 100 is optionally a component of a tablet, a standalone track pad (e.g., Magic Trackpad by Apple Inc.) or other accessory device.

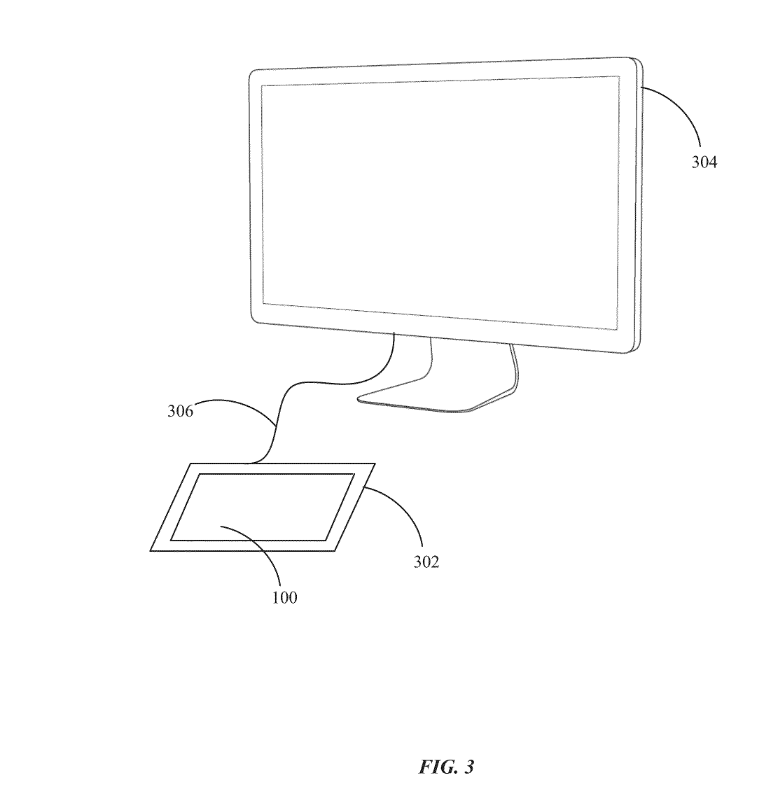

FIG. 3 illustrates an accessory device 302 including touch-sensitive surface 100. User input device 302 communicates with computing device 304. In various embodiments, computing device 304 is a personal computer, laptop computer, mobile device, or other device.

Accessory device 302 communicates with computing device 304 via a wired communication connection 306 (such as a USB, FireWire, or other wired communication connection) and/or via a wireless communication connection (such as a Bluetooth, WiFi, or other wireless communication connection). Data transmitted from accessory user input device 302 to computing device 304 includes information regarding one or more contact areas (e.g., 112, 122, 132, 212, 214, 216, etc.) detected by touch-sensitive surface 100. The information regarding a contact area optionally includes information regarding configuration, number, shape, size, etc. of one or more contacts with touch-sensitive surface 100, such as one or more coordinates indicating a particular location on the surface where contact occurs at touch-sensitive surface 100. In some embodiments, where computing device 304 is discussed below, user input device 302 is usable in lieu of computing device 304 to perform various operations.

In various embodiments, touch-sensitive surface 100 is optionally a component of a computing device, such as a track pad of a laptop or a touchscreen of a portable device.

FIG. 4 illustrates a portable device 402 including a touch-sensitive surface 100 that is a touchscreen. In some embodiments, portable device 402 is a portable media device (e.g., an iPhone® or iPad®). Portable device 402 determines information regarding a contact area including one or more contacts from input received at touch-sensitive surface 100. Where devices 302 and 304 are discussed below, it will be recognized that portable device 402 is usable to perform various operations in lieu of either or both devices.

In some embodiments, default resting contact areas, default liftoff contact areas, default responses, and/or default associations between liftoff contact areas and responses can be configured for an electronic device. In an example, device 304 is preconfigured to recognize a particular resting contact area and liftoff contact area (e.g., a liftoff contact area 122 as shown in FIG. 1D which is detected after a resting contact area shown at FIG. 1B 112 is detected). In another example, device 304 is preconfigured with a set of predefined responses (e.g., a response that selects a currently highlighted selectable item, a response that advances a highlight cursor to a subsequent selectable item, etc.). In a further example, device 304 is preconfigured with a default response stored in association with a default liftoff contact area. Optionally, default liftoff contact areas, default responses, and/or default associations between liftoff contact areas and responses are reconfigurable by a user.

In various embodiments, a user can define input settings such as resting contact areas, liftoff contact areas, responses, and/or associations between liftoff contact areas and responses. A user with limited mobility may only be able to lift two of their fingers together or may have difficulty fully extending a finger. Such users may have difficulty performing default gestures that require a use to move fingers independently or fully extending digits. A user may benefit from a system that allows the user to define a gesture that will easily be repeated by the user in the future. An application may prompt a user to provide input for creating user-defined input settings.

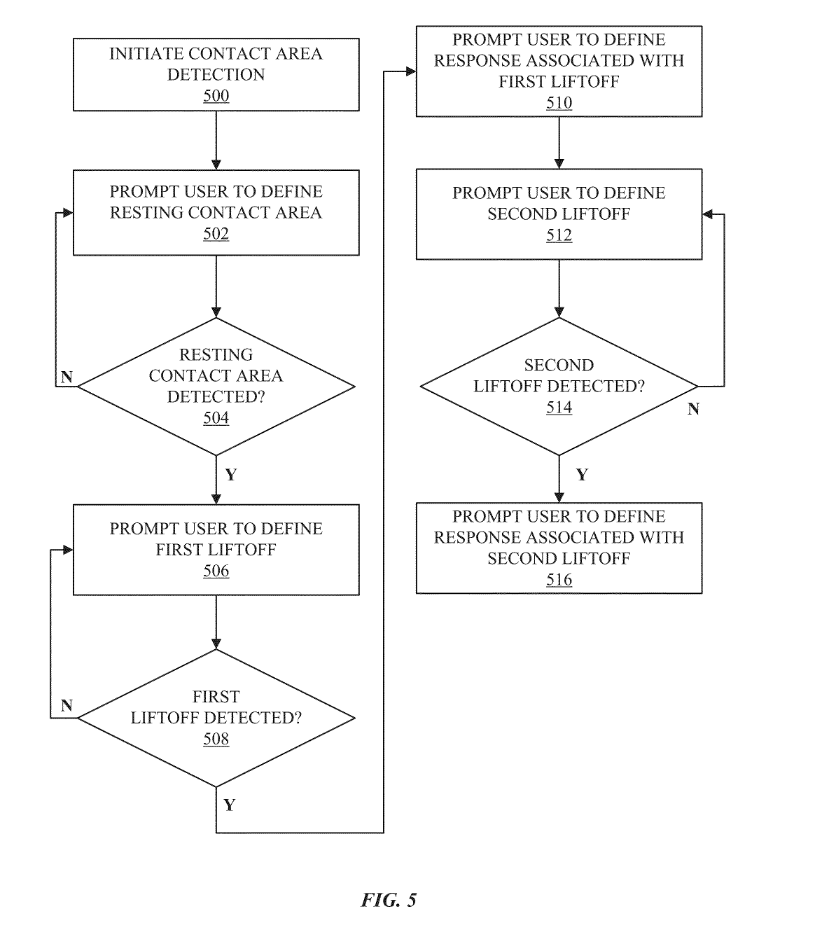

FIG. 5 is a flow diagram illustrating a method for prompting a user to define input settings, in accordance with an embodiment.

At operation 500, a contact area detection mode is initiated at device 304. For example, a contact area detection mode is initiated when a user selects an option presented by a user interface of the device 304 to define contact areas and/or responses.

At operation 502, device 304 prompts the user to define a resting contact area. For example, the device provides audio instructions via a speaker or displays text instructions via a display to request that the user provide a desired resting contact area, e.g., by placing fingers or a foot on device 302. In response to the prompt, the user indicates a desired resting contact area. An example of a resting contact area is contact area 112 described with reference to FIGS. 1A-1B. Another example of a resting contact area is contact area 212 described with reference to FIGS. 2A-2B.

At operation 504, device 304 determines whether a resting contact area is detected. For example, device 304 determines whether signals received from device 302 indicate that a user has made contact with touch-sensitive surface 100. In some embodiments, detecting a resting contact area requires that a detected contact area exceed a threshold minimum area. If a resting contact area is not detected, flow returns to operation 502. Optionally, device 304 provides feedback to the user, e.g., by providing potential reasons why a contact area was not detected. If a resting contact area is detected, device 304 stores a representation of the resting contact area and flow proceeds to operation 506. Optionally, device 304 displays feedback to a user indicating a detected resting contact area, e.g., while the user is providing input or after a resting contact area is detected.

It will be recognized that various techniques are usable to store a representation of a contact area. An example of a representation of a contact area is an array of pixel coordinates or other coordinates indicating where contact occurs with touch-sensitive surface 100. Another example of a representation of a contact area is an image file corresponding to pixels of touch-sensitive surface 100 with pixels having a value indicating where (and, in some embodiments, with what level of pressure) contact occurs with touch-sensitive surface 100.

At operation 506, device 304 prompts the user to define a first liftoff contact area. For example, the device provides audio instructions via a speaker or displays text instructions via a display to request that the user indicate a desired first liftoff contact area, e.g., by raising fingers from device 302 or rotating a foot relative to device 302. In response to the prompt, the user indicates a desired first liftoff contact area. An example of a first liftoff contact area is liftoff contact area 122 described with reference to FIGS. 1C-ID. Another example of a first liftoff contact area is liftoff contact area 214 described with reference to FIGS. 2C-2D.

At operation 508, device 304 determines whether a first liftoff contact area is detected. For example, device 304 determines whether signals received from device 302 indicate that a user has made contact with touch-sensitive surface 100 using a contact area that differs from the resting contact area detected at operation 504. In some embodiments, detecting a liftoff contact area requires that an area of one or more contacts to define the first liftoff contact area differs from the resting contact area by a minimum amount. If a liftoff contact area is not detected, flow returns to operation 506. Optionally, device 304 provides feedback to the user, e.g., by providing potential reasons why a first liftoff contact area was not detected. If a liftoff contact area is detected, device 304 stores a representation of the first liftoff contact area and flow proceeds to operation 510. Optionally, device 304 (or device 302 or 402) displays feedback to a user indicating a detected liftoff contact area, e.g., while the user is providing input or after a liftoff contact area is detected.

At operation 510, device 304 prompts the user to define a response associated with the detected first liftoff contact area. For example, the device presents a list of response options and a user selects a response from the list. Alternatively, a user provides an input indicating a response to be associated with the first liftoff contact area, such as a gesture or other input. The response to be associated with the first liftoff contact area is stored in association with a representation of the first liftoff contact area. For example, in an illustrative embodiment, a response to select a currently highlighted selectable interface element is stored in association with the representation of the first liftoff contact area.

At operation 512, device 304 prompts the user to define a second liftoff contact area. In response to the prompt, the user indicates a desired second liftoff contact area. An example of a second liftoff contact area is liftoff contact area 132 described with reference to FIGS. 1E-IF. Another example of a second liftoff contact area is liftoff contact area 116 described with reference to FIGS. 2E-2F.

At operation 514, device 304 determines whether a second liftoff contact area is detected. For example, device 304 determines whether signals received from device 302 indicate that a user has made contact with touch-sensitive surface 100 with a contact area that differs from the resting contact area detected at operation 504 and the first liftoff contact area detected at operation 508. In some embodiments, detecting a second liftoff contact area requires that an area of contacts to define the second liftoff contact area differs from the resting contact area and/or the first liftoff contact area by a minimum amount. If a liftoff contact area is not detected, flow returns to operation 512. Optionally, device 304 provides feedback to the user, e.g., by providing potential reasons why a second liftoff contact area was not detected. If a liftoff contact area is detected, device 304 stores a representation of the second liftoff contact area and flow proceeds to operation 516. Optionally, device 304 (or device 302 or 402) displays feedback to a user indicating a detected liftoff contact area, e.g., while the user is providing input or after a liftoff contact area is detected.

At operation 516, device 304 prompts the user to define a response associated with the detected second liftoff contact area. The response to be associated with the second liftoff contact area is stored in association with a representation of the second liftoff contact area.

In some embodiments, operations 512-516 are repeated to allow a user to define additional liftoff contact areas and responses.

When predefined responses are stored in association with defined and/or default contact areas, a user may provide input to device 304 by altering contact with device 302 from a resting position to various liftoff positions.

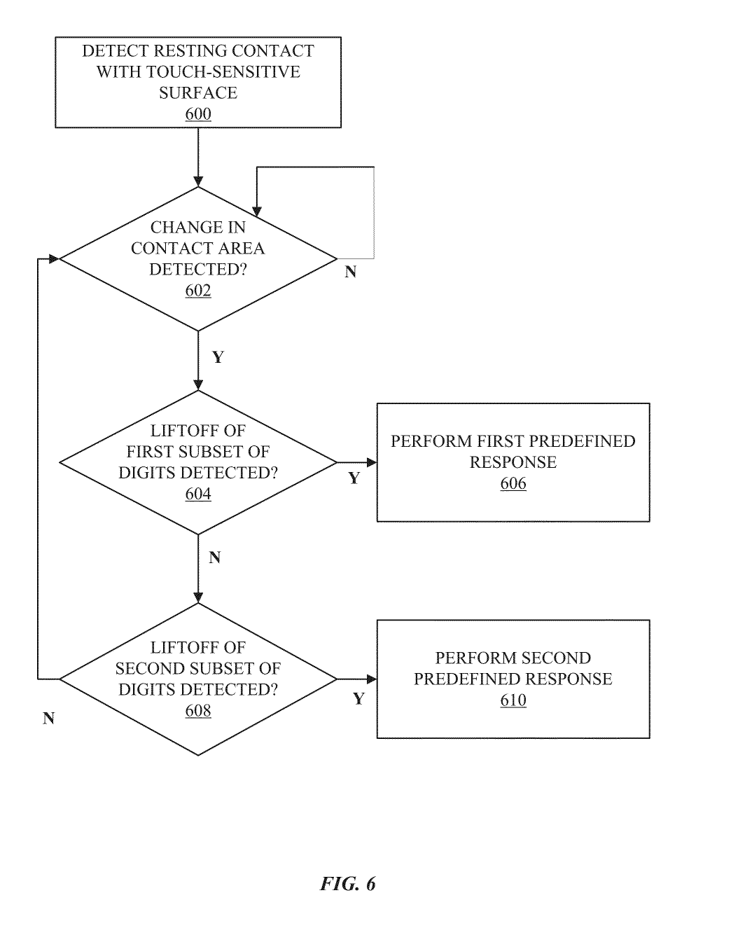

FIG. 6 is a flow diagram illustrating a method for providing input to a device 304 via touch-sensitive surface 100.

At operation 600, device 304 detects a resting contact with touch sensitive surface 100. For example, device 304 receives a signal from device 302 indicating a resting contact with touch-sensitive surface 100. An example of a resting contact area is resting contact area 112 described with reference to FIGS. 1A-1B. Another example of a resting contact area is resting contact area 212 described with reference to FIGS. 2A-2B.

At operation 602, device 304 determines whether a change in the contact area has occurred. For example, device 304 determines whether a signal received from device 302 indicates a change in contact area from the resting contact area detected at operation 600. If no change in contact area is detected, flow returns to operation 602. If a change in contact area is detected, flow proceeds to operation 604.

At operation 604, device 304 determines whether a change in a contact area is a change from a resting contact area to a first liftoff contact area. For example, if a resting position contact area is multiple fingers in contact with touch-sensitive surface 100, as indicated at FIGS. 1A-1B, a first liftoff contact area results, in some embodiments, from liftoff of a first subset of the fingers, as indicated at FIGS. 1C-ID. If a resting position contact area is a foot in contact with touch-sensitive surface 100, as indicated at FIGS. 2A-2B, a first liftoff contact area results, in some embodiments, from the user rolling his foot to his right, as indicated at FIGS. 2C-2D. If a change in a contact area results in a first liftoff contact area, flow proceeds to operation 606. If a change in a contact area does not result in a first liftoff contact area, flow proceeds to operation 608.

At operation 606, device 304 performs a first predefined response. A first predefined response is, for example, a first predefined response stored by device 304 in association with a representation of the first liftoff contact area as detected at operation 604. An example of a first predefined response is selecting a currently highlighted selectable interface element.

At operation 608, device 304 determines whether a change in a contact area is a change from a resting contact area to a second liftoff contact area. For example, if a resting position contact area is multiple fingers in contact with touch-sensitive surface 100, as indicated at FIGS. 1A-1B, a second liftoff contact area results, in some embodiments, from liftoff of a second subset of the fingers (e.g., as indicated at FIGS. 1E-IF) that is different from the first subset of fingers. If a resting position contact area is a foot in contact with touch-sensitive surface 100, as indicated at FIGS. 2A-2B, a second liftoff contact area results, in some embodiments, from the user rolling his foot to the left, as indicated at FIGS. 2E-2F. If a change in a contact area results in a second liftoff contact area, flow proceeds to operation 610. In some embodiments, if a change in a contact area does not result in a first liftoff contact area, flow returns to operation 602.

At operation 610, device 304 performs a second predefined response. A second predefined response is, for example, a second predefined response stored by device 304 in association with a representation of the second liftoff contact area as detected at operation 608. An example of a second predefined response is advancing a selection indicator to a next selectable interface element of a set of selectable interface elements.

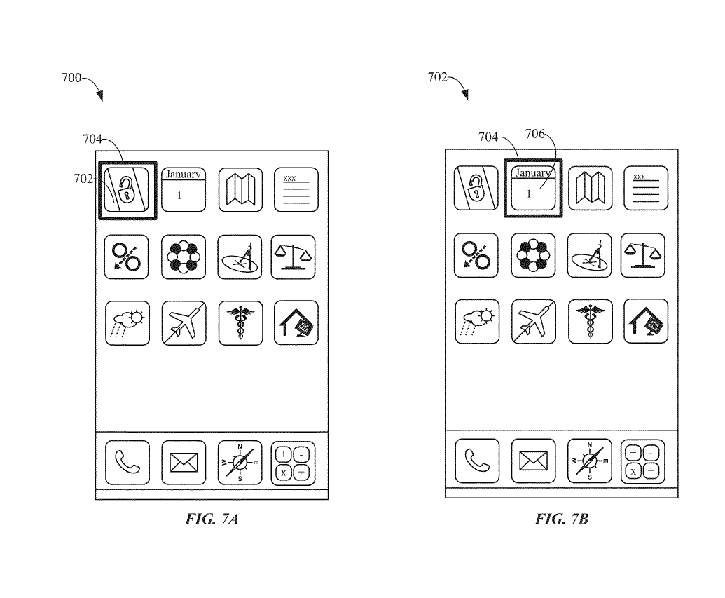

FIGS. 7A-7B illustrate advancing a selection indicator to a next selectable interface element of a set of selectable interface elements, according to an embodiment.

FIG. 7A is an illustrative screen shot 700 of a display, such as a display of device 304 or a display of device 402. Various interface elements are shown in screen shot 700. Interface element 702 is currently highlighted, as indicated by selection indicator 704 surrounding interface element 702. It will be recognized that alternative highlighting techniques are usable, such as causing interface element 702 to move, brightening interface element 702 relative to other displayed interface elements, etc. To select a interface element 706 using a switch control, a user advances a selection indicator 704 from a first interface element 702 to a second interface element 706. In FIG. 7B, screen shot 702 shows selection indicator 704 surrounding interface element 706 to indicate that interface element 706 is currently highlighted.

In an illustrative embodiment, a user advances selection indicator 704 from interface element 702 to interface element 706 by changing a contact area from a resting contact area to a first liftoff contact area. For example, a user advances selection indicator 704 by lifting an index finger from a resting position in which all fingers are in contact with touch-sensitive surface 100.

In some embodiments, selection indicator 704 continually scrolls between interface elements 702, 704, etc., until the scrolling is stopped by the user. A user initiates continuous scrolling and/or stops selection indicator 704 at a desired interface element, for example, by changing a contact area from a resting contact area to a liftoff contact area.

In an illustrative embodiment, if the user wishes to select interface element 706, the user changes a contact area from a resting contact area to a second liftoff contact area. For example, a user selects interface element 706 by lifting a middle finger and a ring finger from a resting position in which all fingers are in contact with touch-sensitive surface 100.

By recognizing information associated with a resting contact area and/or liftoff contact area, such as a configuration, number, shape, size, etc. of contacts that are associated with a contact area, device 304 recognizes various configurations of contacts. In this way, a user with limited mobility is enabled to provide input at a location that is most reachable and/or comfortable for a user.

A user may not always provide input at the same portion of touch-sensitive surface 100. For example, a user may adjust his position relative to device 302, resulting in contact being made at a different portion of touch-sensitive screen 100. In some embodiments, device 304 is able to recognize a resting contact area and/or a liftoff contact area by recognizing a contact area pattern. In this way, device 304 can recognize a contact area regardless of the portion of touch-sensitive screen 100 where the contact is made.

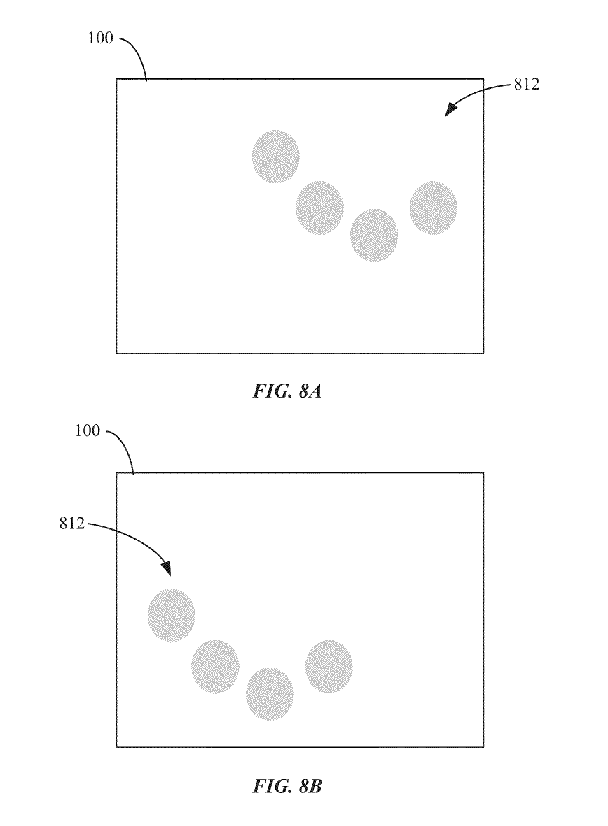

FIGS. 8A-8B illustrate a contact area 812 received at different portions of touch-sensitive screen 100. In FIGS. 8A-8B, contact area 812 is illustrated by resting contact area 112 as shown at FIG. 1B. FIG. 8A shows contact area 812 in the upper right corner of touch-sensitive screen 100. FIG. 8B shows contact area 812 in the lower left corner of touch-sensitive screen 100. By recognizing information associated with contact area 812, such as a configuration, number, shape, size, etc. of contacts associated with contact area 812, device 304 is capable of recognizing contact area 812 as being resting contact area 112 when contact area 812 occurs at a first position as shown in FIG. 8A and when contact area 812 occurs in a second position as shown in FIG. 8B.

A user may change the arrangement of a contact area. For example, when placing fingers in a resting position on touch-sensitive surface 100, a user may change a spacing between fingers to allow the user to better view content shown on a display of device 302 or device 402. In some embodiments, device 304 is able to recognize a resting contact area and/or a liftoff contact area by recognizing discrete contact areas. In this way, device 304 can recognize a contact area regardless of arrangement of discrete contact points.

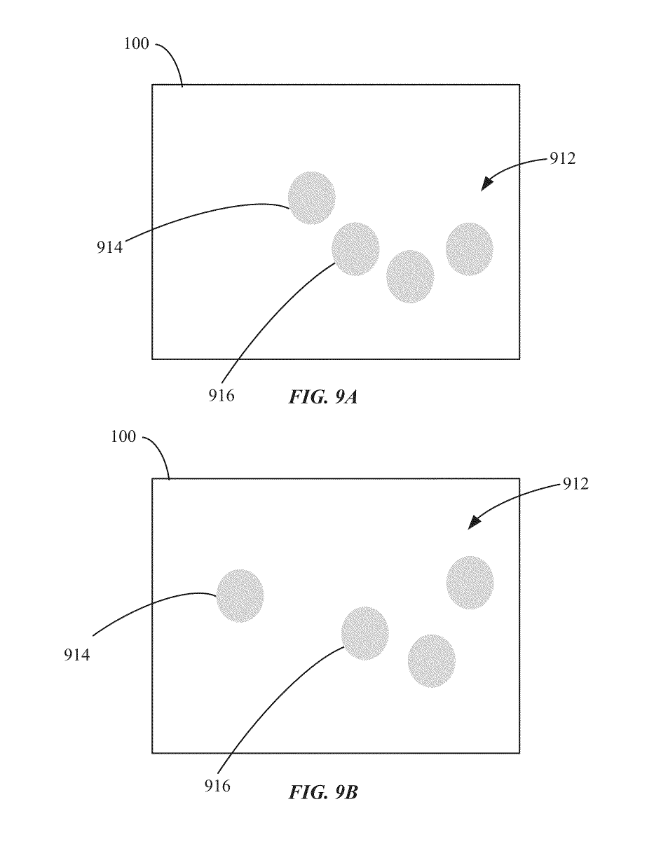

FIGS. 9A-9B illustrate various arrangements of discrete contact points of a contact area 912. In FIG. 9A contact area 912 is illustrated by resting contact area 112 as shown at FIG. 1B. In FIG. 9B, the spacing between contact points 914 and 916 of contact area 912 has widened relative to the spacing between contact points 914 and 916 as shown in FIG. 9A. By recognizing information associated with contact area 912, such as a configuration, number, shape, size, etc. of contacts associated with contact area 912, device 304 is capable of recognizing contact area 912 as being resting contact area 112 when contact area 912 has a first spacing between discrete contacts as shown in FIG. 9A and when contact area 912 has a second spacing between discrete contacts as shown in FIG. 9B.

A user may change the orientation of a contact area. For example, if a user's right hand becomes fatigued, the user may wish to provide input with his left hand. In some embodiments, device 304 is able to recognize a resting contact area and/or a liftoff contact area when provided by an opposite hand of the hand for which responses have been configured. Similarly, in various embodiments, device 304 is able to recognize a resting contact area and/or a liftoff contact area when provided by an opposite set of digits, foot, or other body part.

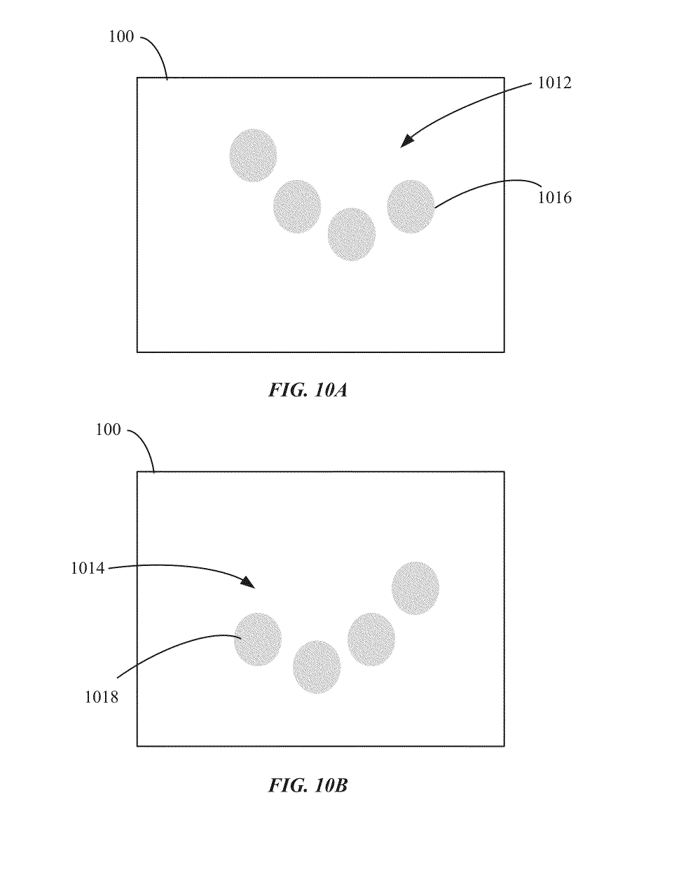

FIGS. 10A-10B illustrate contact area 1012 provided by a right hand at touch-sensitive screen 100 and contact area provided by a left hand at touch-sensitive screen 100. In FIG. 10A, contact area 1012 is illustrated by resting contact area 112 as shown at FIG. 1B. Contact area 1012 is a resting position of a user's right hand on touch-sensitive surface 100. In FIG. 10B, contact area 1014 is a resting position of the user's left hand on touch-sensitive surface 100. Device 304 recognizes resting contact area 1014 as being the same resting contact area as resting contact area 1012. If a liftoff of index finger contact 1016 of contact area 1012 results in a first response, a liftoff of index finger contact 1018 of contact area 1014 also results in the first response. By recognizing information associated with contact area 1012, such as a configuration, number, shape, size, etc. of contacts associated with contact area 1012, device 304 is capable of recognizing contact area 1014 as being equivalent to contact area 1012.

In some embodiments, a user provides input indicating that the user will stop providing input with a first hand (or other body part) and begin providing input with an opposite hand (or other body part). In an illustrative example, a swipe of a finger across touch-sensitive surface 100 indicates that a transition from right hand input to left hand input will occur. In another example, a transition is indicated with a gesture such as an “x” or “+” symbol drawn on touch-sensitive surface 100.

When all contacts have been lifted off of touch-sensitive surface 100, device 302 optionally exits from a mode in which input is provide via changes in a contact area.

In some embodiments, input is provided via two or more touch-sensitive surfaces 100. In one example, a user provides input using a right hand at a first touch-sensitive surface 100 and using a left hand using a second touch-sensitive surface 100. In another example, a user provides input using a right hand at a first touch-sensitive surface 100 and a right foot at a second touch-sensitive surface. The predefined responses associated with inputs received at the first touch-sensitive surface and the second touch-sensitive surface may be the same, or one or more predefined responses associated with a first touch-sensitive surface may be different from one or more predefined responses associated with a second touch-sensitive surface. In some embodiments, a user provides input simultaneously using two or more touch-sensitive surfaces. In another embodiment, a user provides an input, such as a swipe or other gesture, indicating that the user will stop providing input at a first touch-sensitive surface 100 and being providing input at a second touch-sensitive surface.

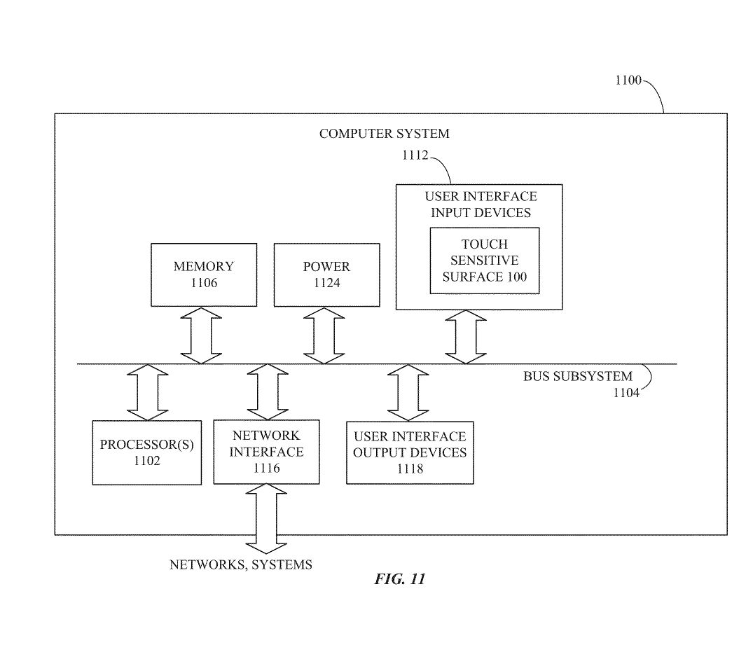

FIG. 11 is a simplified block diagram of a computer system 1100, according to an embodiment. Devices 302, 304, 402 optionally incorporate various elements as described with reference to FIG. 11. As shown in FIG. 11, computer system 1100 includes one or more processors 1102 that communicate with a number of subsystems via a bus subsystem 1104. These subsystems include, for example, a storage subsystem 1106, user interface input devices 1112, user interface output devices 1118, and a network interface subsystem 1116.

Bus subsystem 1104 provides a mechanism for letting the various components and subsystems of computer system 1100 communicate with each other as intended. Although bus subsystem 1104 is shown schematically as a single bus, alternative embodiments of the bus subsystem optionally utilize multiple busses.

Processor 1102, which can be implemented as one or more integrated circuits (e.g., a conventional microprocessor or microcontroller), controls the operation of computer system 1100. One or more processors 1102 are provided. These processors optionally include single core or multicore processors. In various embodiments, processor 1102 can execute a variety of programs in response to program code and can maintain multiple concurrently executing programs or processes. At any given time, some or all of the program code to be executed can be resident in processor(s) 1102 and/or in storage subsystem 1106. Through suitable programming, processor(s) 1102 can provide various functionalities described above.

Network interface subsystem 1116 provides an interface to other computer systems and networks. Network interface subsystem 1116 serves as an interface for receiving data from and transmitting data to other systems from computer system 1100. For example, network interface subsystem 1116 enables computer system 1100 to connect to one or more devices via the Internet. In some embodiments network interface 1116 can include radio frequency (RF) transceiver components for accessing wireless voice and/or data networks (e.g., using cellular telephone technology, advanced data network technology such as 3G, 4G or EDGE, WiFi (IEEE 802.11 family standards, or other mobile communication technologies, or any combination thereof), GPS receiver components, and/or other components. In some embodiments network interface 1116 can provide wired network connectivity (e.g., Ethernet) in addition to or instead of a wireless interface.

User interface input devices 1112 optionally include a touch-sensitive surface 100. User interface input devices optionally further include, pointing devices such as a mouse or trackball, a touchpad or touch screen incorporated into a display, a scroll wheel, a click wheel, a dial, a button, a switch, a keypad, audio input devices such as voice recognition systems, microphones, and other types of input devices. In general, use of the term “input device” is intended to include all possible types of devices and mechanisms for inputting information to computer system 1100.

User interface output devices 1118 optionally include a display subsystem, indicator lights, or non-visual displays such as audio output devices, etc. The display subsystem includes, for example, one or more of a cathode ray tube (CRT), a flat-panel device such as a liquid crystal display (LCD), a projection device, a touch screen, and the like. In general, use of the term “output device” is intended to include all possible types of devices and mechanisms for outputting information from computer system 1100.

Storage subsystem 1106 provides a computer-readable storage medium for storing the basic programming and data constructs that provide the functionality of some embodiments. Storage subsystem 1106 can be implemented, e.g., using disk, flash memory, or any other storage media in any combination, and can include volatile and/or non-volatile storage as desired. Software (programs, code modules, instructions) that when executed by a processor provide the functionality described above are stored in storage subsystem 1106. These software modules or instructions are executed by processor(s) 1102. Storage subsystem 1106 also provides a repository for storing data used in accordance with the present invention. Storage subsystem 1106 optionally includes a memory subsystem and a file/disk storage subsystem.

A memory subsystem optionally includes a number of memories including a main random access memory (RAM) for storage of instructions and data during program execution and a read only memory (ROM) in which fixed instructions are stored. A file storage subsystem provides persistent (non-volatile) storage for program and data files, and include, e.g., a hard disk drive, a floppy disk drive along with associated removable media, a Compact Disk Read Only Memory (CD-ROM) drive, an optical drive, removable media cartridges, and other like memory storage media.

The computer device 1100 also includes a power system 1124 for powering the various hardware components. The power system 1124 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

Computer system 1100 can be of various types including a personal computer (e.g., a MacBook®, an iMac®), a portable device (e.g., an iPhone®, an iPad®), a workstation, a network computer, a mainframe, a kiosk, a server or any other data processing system. Due to the ever-changing nature of computers and networks, the description of computer system 1100 depicted in FIG. 11 is intended only as a specific example. Many other configurations having more or fewer components than the system depicted in FIG. 11 are possible.

Various embodiments described above can be realized using any combination of dedicated components and/or programmable processors and/or other programmable devices. The various embodiments are implementable only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for interprocess communication, and different pairs of processes optionally use different techniques, or the same pair of processes use different techniques at different times. Further, while the embodiments described above make reference to specific hardware and software components, those skilled in the art will appreciate that different combinations of hardware and/or software components are also be usable and that particular operations described as being implemented in hardware might also be implemented in software or vice versa.

The various embodiments are not restricted to operation within certain specific data processing environments, but are free to operate within a plurality of data processing environments. Additionally, although embodiments have been described using a particular series of transactions, this is not intended to be limiting.

Thus, although specific invention embodiments have been described, these are not intended to be limiting. Various modifications and equivalents are within the scope of the following claims.

What is claimed is:

1. A method, comprising:
at an electronic device with one or more processors, a touch-sensitive surface, and memory:
detecting a contact area of a set of one or more contacts on the touch-sensitive surface, wherein a plurality of changes in the contact area are mapped to corresponding predefined responses;
after detecting the contact area, detecting a change in the contact area that includes a liftoff of at least a portion of one of the set of one or more contacts from the touch-sensitive surface while at least a portion of the contact area is maintained on the touch-sensitive surface; and
in response to detecting the change in the contact area:
in accordance with a determination that the change is a first change in the contact area, performing a first predefined response; and
in accordance with a determination that the change is a second change in the contact area, performing a second predefined response that is different from the first predefined response.

2. The method of claim 1, wherein the set of one or more contacts includes a set of digits, wherein the first change in the contact area includes a lift off of a first subset including one or more of the set of digits, wherein the second change in the contact area includes a liftoff of a second subset including one or more of the set of digits, wherein the first subset is different from the second subset.

3. The method of claim 1, wherein the first change in the contact area includes a rolling motion in a first direction and the second change in the contact area includes a rolling motion in a second direction that is different from the first direction.

4. The method of claim 1, wherein a predefined response is at least one of: selecting a currently highlighted selectable interface element, advancing a selection indicator to a next selectable interface element of a set of selectable interface elements, moving a selection indicator to a previous selectable interface element of a set of selectable interface elements, and initiating scrolling between selectable interface elements.

5. The method of claim 1, wherein the mapping between changes in the contact area and the predefined responses is relative to the set of one or more contacts when the contact area is detected on the touch-sensitive surface.

6. The method of claim 1, wherein at least one of the first change in the contact area and the second change in the contact area are recorded by a user.

7. The method of claim 1, wherein a first orientation is associated with the set of one or more contacts, and further comprising:
receiving an input indicating a change from the first orientation to a second orientation;
detecting a contact area of a second set of one or more contacts on the touch-sensitive surface, wherein a second orientation is associated with the second set of one or more contacts; and
in response receiving the input indicating the change from the first orientation to the second orientation, remapping the first predefined response to a change in the contact area of the second set of one or more contacts.

8. The method of claim 1, wherein the input indicating a change from the first orientation to the second orientation is a movement of the set of one or more contacts from a first location on the touch-sensitive surface to a second location on the touch-sensitive surface, wherein the set of one or more contacts is in continuous contact with the touch-sensitive surface during the movement.

9. An electronic device, comprising:
one or more processors;
a touch-sensitive surface;
memory; and
one or more programs, wherein the one or more programs are stored in the memory and configured to be executed by the one or more processors, the one or more programs including instructions for:
detecting a contact area of a set of one or more contacts on the touch-sensitive surface, wherein a plurality of changes in the contact area are mapped to corresponding predefined responses;
after detecting the contact area, detecting a change in the contact area that includes a liftoff of at least a portion of one of the set of one or more contacts from the touch-sensitive surface while at least a portion of the contact area is maintained on the touch-sensitive surface; and
in response to detecting the change in the contact area:
in accordance with a determination that the change is a first change in the contact area, performing a first predefined response; and
in accordance with a determination that the change is a second change in the contact area, performing a second predefined response that is different from the first predefined response.

10. The electronic device of claim 9, further comprising a touchscreen including the touch-sensitive surface.

11. The electronic device of claim 9, further comprising a touchpad including the touch-sensitive surface.

12. A non-transitory computer readable storage medium storing one or more programs, the one or more programs comprising instructions, which when executed by an electronic device with one or more processors and memory, cause the device to:
detect a contact area of a set of one or more contacts on the touch-sensitive surface, wherein a plurality of changes in the contact area are mapped to corresponding predefined responses;
after detecting the contact area, detect a change in the contact area that includes a liftoff of at least a portion of one of the set of one or more contacts from the touch-sensitive surface while at least a portion of the contact area is maintained on the touch-sensitive surface; and
in response to detecting the change in the contact area:
in accordance with a determination that the change is a first change in the contact area, perform a first predefined response; and
in accordance with a determination that the change is a second change in the contact area, perform a second predefined response that is different from the first predefined response.

13. The non-transitory computer readable storage medium of claim 12, wherein the set of one or more contacts includes a set of digits, wherein the first change in the contact area includes a liftoff of a first subset including one or more of the set of digits, wherein the second change in the contact area includes a liftoff of a second subset including one or more of the set of digits, wherein the first subset is different from the second subset.

14. The non-transitory computer readable storage medium of claim 12, wherein the first change in the contact area includes a rolling motion in a first direction and the second change in the contact area includes a rolling motion in a second direction that is different from the first direction.

15. The non-transitory computer readable storage medium of claim 12, wherein a predefined response is at least one of: selecting a currently highlighted selectable interface element, advancing a selection indicator to a next selectable interface element of a set of selectable interface elements, moving a selection indicator to a previous selectable interface element of a set of selectable interface elements, and initiating scrolling between selectable interface elements.

16. The non-transitory computer readable storage medium of claim 12, wherein the mapping between changes in the contact area and the predefined responses is relative to the set of one or more contacts when the contact area is detected on the touch-sensitive surface.

17. The non-transitory computer readable storage medium of claim 12, wherein at least one of the first change in the contact area and the second change in the contact area are recorded by a user.

18. The non-transitory computer readable storage medium of claim 12, wherein a first orientation is associated with the set of one or more contacts, and further comprising:
receiving an input indicating a change from the first orientation to a second orientation;
detecting a contact area of a second set of one or more contacts on the touch-sensitive surface, wherein a second orientation is associated with the second set of one or more contacts; and
in response receiving the input indicating the change from the first orientation to the second orientation, remapping the first predefined response to a change in the contact area of the second set of one or more contacts.

19. The non-transitory computer readable storage medium of claim 18, wherein the input indicating a change from the first orientation to the second orientation is a movement of the set of one or more contacts from a first location on the touch-sensitive surface to a second location on the touch-sensitive surface, wherein the set of one or more contacts is in continuous contact with the touch-sensitive surface during the movement.

20. A method, comprising:
at an electronic device with one or more processors, a touch-sensitive surface, and memory:
detecting a contact of three digits on the touch-sensitive surface
detecting a liftoff of at least one digit of the three digits, wherein a liftoff of a first digit of the three digits is mapped to a first predefined response and a liftoff of at least one of a second digit and a third digit of the three digits is mapped to a second predefined response;
in response to detecting the liftoff of the at least one digit of the three digits:
in accordance with detecting a liftoff of the first digit of the three digits, performing a first predefined response; and
in accordance with detecting a liftoff of at least one of the second digit and the third digit of the three digits, performing a second predefined response that is different from the first predefined response.

21. The method of claim 20, wherein a predefined response is at least one of: selecting a currently highlighted selectable interface element, advancing a selection indicator to a next selectable interface element of a set of selectable interface elements, moving a selection indicator to a previous selectable interface element of a set of selectable interface elements, and initiating scrolling between selectable interface elements.
